(19) United States
(12) Patent Application Publication
(10) Pub. No.: US 2012/0169161 A1
(43) Pub. Date: Jul. 5, 2012

(54) DISK MOTOR USING A PERMANENT MAGNET AND BYPASSING THE MAGNETIC FORCE OF THE MAGNET

(76) Inventor: Kyoung-Sik Woo, Busan (KR)

(21) Appl. No.: 13/496,519

(22) PCT Filed: Aug. 17, 2010
(86) PCT No.: PCT/KR2010/005406

§ 371 Date: Mar. 16, 2012

(30) Foreign Application Priority Data
Sep. 21, 2009 (KR) 10-2009-0088888

(51) Int. Cl. H02K 21/24; H02K 9/02; H02K 53/00

(52) U.S. Cl. 310/59; 310/156.36; 74/DIG. 9

(57) ABSTRACT

The present invention relates to a disk-type motor using a permanent magnet, wherein the permanent magnet is arranged on a disk-type rotor (300), and a stator core (202) and a power-generating coil (204) are arranged on a stator (200) to obtain a high-efficiency motor which self-generates power upon being driven. (2) A special device is needed to reduce the consumption of electrical energy for driving a motor, and a special circuit for bypassing the magnetic force of a magnet is also needed. (3) To bypass the magnetic force, a bypass core (101.205) and a magnetic core (301) are employed to constitute a circuit for bypassing the magnetic force, and a magnetic flux path for bypassing the magnetic force is formed. Thus, a special circuit which can significantly reduce the consumption of electrical energy is obtained. (4) The motor of the present invention can be used in all fields that require power and energy, in a vehicle motor, in a motor used as a source of power, in a motor for generating is electric power, etc. The motor of the present invention is advantageous in that it can reduce the consumption of fossil fuel, produce clean energy, and reduce carbon dioxide, thus contributing to human health.

### TECHNICAL FIELD

The present invention relates to a disk motor using a permanent motor. The motor is classified into a motor using a permanent magnet and a motor using an induced electronic current. The kinds of the motor reach around 12-15. In terms of the characteristic of the motors, a common induction motor has an efficiency of around 30-50%, and a DC magnet motor has an efficiency of around 70%, and a coreless motor has an efficiency of around 80-90%; however it is hard to make such motors larger. The present invention is basically directed to providing a permanent magnet bypass disk motor which makes larger the motor with a high efficiency in such a way to effectively use a is permanent magnet and which is capable of generating electric power.

### BACKGROUND ART

A conventional motor using a permanent magnet is made from a ferrite or a neodymium magnet, most of which motors are small sized DC motors and are mainly formed of a permanent magnet, a stator core, a driving coil and a rotor.

The present invention is directed to providing a disk type motor using the magnetic force of a permanent magnet, in which a stator core and both sides of a magnet are used, and a magnetic force bypass circuit, which is not known so far, is invented, so the consumption of an electric energy supplied to a winding coil so as to generate a repulsive force for driving can be minimized, and there is provided a structure which allows a self electric power generation as it starts driving. When getting started, an electric power is supplied from a common electric power or a battery, and when in a normal operation, the self-generated electric power is rectified and stored in a battery, and the motor is driven using the stored electric power, and when battery lacks electric power, electric power is supplied from an auxiliary battery or a common electric power, thus significantly reducing the consumption of electric energy.

### Disclosure of Invention

Accordingly, it is an object of the present invention to provide, in consideration with the above technical problems, a specific circuit and structure which are characterized in that a stator core of a silicon steel plate is arranged at a stator corresponding to a magnet of a rotor so as to use a suction force of a permanent magnet in maximum, and the magnet of a rotor is sucked in, and when the sucked magnet escapes from a stator core, the suction force (magnetic force) of a magnet with respect to a stator core is reduced, thus achieving an easier escape of the same.

In addition, a self electric power generation is achieved by adapting a structure which makes it possible to generate electric power at the time a motor starts driving, thus enhancing operation efficiency by minimizing the consumption of electric energy for a driving, and the present invention can be well applied to making a motor larger which was a limitation in a permanent magnet motor.

In a permanent magnet bypass disk motor according to the present invention, a stator and a rotor are made in a circular dish shape, and a stator core of a stator and both sides of a magnet of a rotor are used, thus doubling efficiency.

A stator is formed of a stator core made from a silicon steel plate, and a is winding coil is wound thereon, and in terms of a magnet which is sucked into a stator core, a signal is received by way of a sensor depending on the position of a magnet of a rotor, and a counter magnetic force for the poles N and S is generated at a winding coil, and a rotation is conducted by pushing the magnet.

A bonding coil of a coreless is wound and arranged in a space between a stator core of a stator and the next stator core, thus generating an electric power with the aid of rotating magnetic field. Since a bonding coil does not have steel core, electric power is generated without having a load change based on Coulomb's law, provided that since there is not a steel core which is a magnetic field flow passage, a short distance is needed between the pole N and the pole S, and the stronger the gauss of magnetic field is, the higher the efficiency of electric power generation is. When the base of the stator is made from steel or non-ferrous metal, since the rotation is interfered with Joule heat due to the magnetic force of a rotor or Arago disk law, it is needed to process using a material such as a high strength resin plate.

The rotor is characterized in that a base is made from a disk type non ferrous metal such as aluminum or something, and a magnet core of a certain size of and number (poles) is arranged based on the size and output of a motor. The base is made from a non ferrous metal such as aluminum, copper, etc, because the driving of a rotor is not interfered with such non ferrous metals.

The operation of a squirrel cage rotor corresponding to a magnetic field generating by means of a stator core of a motor might be expected. An air hole is formed at the center of a rotary shaft so as to cool motor, with one side of the air hole being slanted like the teeth of a comb, the structure of which helps suck and discharge air during the rotation, thus enhancing the cooling of the motor.

The permanent magnet bypass disk motor according to the present invention is invented to include a bypass core forming a new structure magnetic force bypass circuit for efficiently driving a motor and a magnet core which is used as a magnetic flux passage.

The magnetic force bypass core is formed of a magnet core which is used as a magnetic flux passage, in which a pure iron or a silicon steel plate covers both sides of a magnet of a rotor and is adhered, thus facilitating the magnet of a rotor sucked into a stator core of a silicon steel plate installed at a disk type stator to escape easily.

The bypass core is made from a metal having a low magnetic resistance such as a pure iron or a silicon steel plate. An external bypass core is fixedly disposed at a housing between the motor stator and the stator. When the end portion of the magnet core reaches the position of a certain bypass core as the rotor rotates, the magnet core and the bypass core come into contact with each other and undergo rotations. When they come into contact with each other and undergo rotations, the poles N and S of the magnet core are connected, and the magnetic force is bypassed via the bypass core by way of the magnetic flux passage of the steel, not the stator core, thus consequently forming a closed-magnetic circuit. So, the magnetic force for the stator core decreases, so the magnetic core can escape easily. Since the magnet core of the rotor, of which the magnetic force is not decreased, is strongly sucked into the corresponding stator core, the magnet core in the bypass core can easily escape. The magnetic force bypass core is installed at the side of the driving shaft, and then it is fixed at the stator.

The steel plate which belongs to the magnet core and the bypass core is generally made from a pure iron or a silicon steel plate which has a small magnetic resistance because as the rotor rotates, the poles of the magnet are alternately changed, and the poles of the stator core are alternately changed, so the resistance does not affect magnetic flows.

The consumptions of the electric power needed for the driving of the motor can be significantly decreased with the aid of the magnetic force decrease effects obtained by the magnetic force bypass core and the self-electric power generation functions according to the present invention, so the present invention can be widely applied to all fields where need driving force and energy. The present invention might help a globe environment protection is along with a carbon dioxide reduction effect thanks to the decrease in the use of fossil fuel.

### BRIEF DESCRIPTION OF DRAWINGS

FIG. 1 is a side cross sectional view according to the present invention.

FIG. 2 is a view illustrating a structure of a stator according to the present invention.

FIG. 3 is a view illustrating a rotor according to the present invention.

### BEST MODES FOR CARRYING OUT THE INVENTION

The detailed embodiments of the present invention will be described with reference to the accompanying drawings as follows.

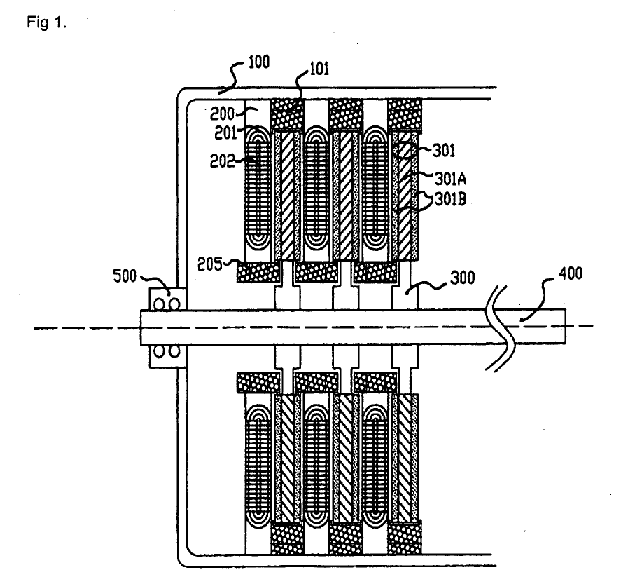

FIG. 1 is a side cross sectional view of the present invention. In the present invention, a circular disk-shaped stator 200 is coupled to a housing 100 in a circular housing 100, and the stator 200 is made from a high strength resin or something which is not a non-ferrous metal.

When it is made from a non-ferrous metal, Joule heat is generated when the magnet of the rotor 300 rotates, and the rotation is interrupted based on Arago disk law.

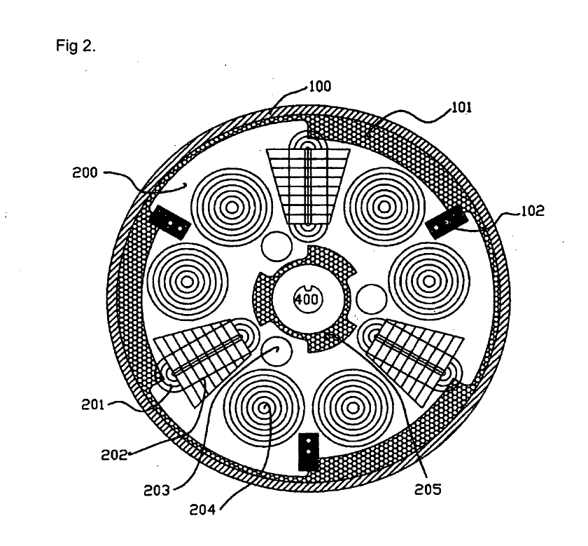

As shown in FIG. 2, the stator 200 is characterized in that the stacked stator core 202 made from a silicon steel plate has a certain pole determined depending on the size and power of the motor. A driving coil 201 is wound on the stator core 202, and when the magnet coil 301 sucked in the stator core 202 stroke-escapes during the driving of the motor, it is designed to escape by means of a repulsive magnetic force of the repulsive electric current flowing at the driving coil depending on the signal of the sensor 102.

The electric power generation coil 204 is made from a coreless bonding coil and is disposed in a space of the stator core 202, thus generating electric power with the aid of an induced magnetic field during the rotation of the magnet of the rotor. The generated electric power is stored in the battery after it is rectified.

Here, a non-load electric power generation can be made based on Coulomb's law without having any suction force resistance of iron loss since there is not a steel core at the electric power generation coil 204.

An air circulation port 203 is formed at the center of the stator 200 so as to cool the heat from the motor. The air hole 304 based on the rotational force generating during the rotation of the rotor 300 is made in a comb teeth shape, thus cooling the heat from the motor by circulating the air.

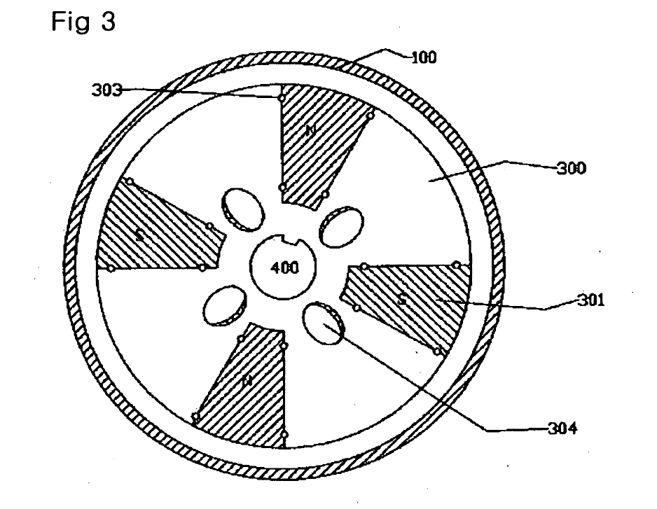

The base of the rotor 300 of FIG. 3 can be made from a non-ferrous metal, a high strength resin or something, and a magnet core 301 is corresponding to the stator core 202 is made. As shown at the reference number 301 of FIG. 1, a silicon steel plate or a pure iron plate 301b cover both sides of a permanent magnet 301a and is adhered for the reasons that the permanent magnet 301a is made from an anisotropy magnet, thus generating a magnetic force in two directions, and the generated magnetic force is applied to the stator core 202, and then the magnet core 301 is sucked, and the magnetic force is bypassed by means of the bypass cores 101 and 205, and the magnetic force for the stator core 202 can decrease, the operations of which are directed to using a magnetic flux passage.

The poles N and S in the magnetic force of the magnet core 301 are alternatively changed, so the magnet core steel plate 301b to be used as a magnetic flux passage is preferably made from a silicon steel plate or a pure iron plate which has a small magnetic resistance.

There is provided a bypass core 101, 205 so as to generate a bypass circuit by which it is possible to easily escape the magnet core 301, sucked into the stator core 202, by decreasing the magnetic force. As for the position, it is designed that the magnetic force can bypass via the bypass core 101, 205 and can decrease from the time when the magnetic core 301 is sucked at half the target position in the stator core 202, so the magnetic force can decrease while the bypass circuit operates until the magnet core 202 fully escapes from the stator core 202.

The important thing is that the bypass cores 101 and 205 have a gap (air gap) from the magnet core 301 smaller than the gap from the stator core 202, thus making better the flow of the magnetic flux. As the magnet core 301 of the rotor enters the position of the bypass core 101, 205, the magnetic force flowing via the stator core 202 in the magnetic core 301 flows to the bypass core 101, 205 by way of the pure iron plate 301b of the magnet core 301 and is bypassed, so the magnetic force for the stator core 202 decreases.

When the magnet core 301 enters the position of the bypass core 101, 205 while the magnetic force is flowing from the magnet core 301 to the stator core 202, the magnetic force bypasses to the bypass core 101, 205 by way of the magnet core 301, so the magnetic force decrease effects for the stator core 202 are obtained, thus making easier the rotation of the rotor 300 and decreasing the consumption of the electric power energy when generating repulsive magnetic force.

Since the suction force and the escape resistance of the bypass core 101, 205 are offset by their corresponding poles in case of a triple-pole structure, big difference does not occur in their loads. In case of a triple-pole structure, while the number 1 is about to enter the stator core 202, the number 2 is just before suction, and the number 3 is in an escape completion state, thus is balancing the suction and discharge, so that the increase in terms of the load by the bypass core 101, 205 is small.

The motor according to the present invention, in case that the increase or decrease of power is needed, is directed to increasing or decreasing its output power by increasing the value zero of the rotor 300 or stacking the disks of the stator 200 and the rotor 300 or increasing or decreasing the stacked disks, and the increase and decrease of the speed during the operation can be simply controlled by adjusting the flow of the electric current with respect to the driving coil 201.

1. A disk motor using a permanent magnet and bypassing the magnetic force of the magnet, comprising:
a stator 200 and a rotor 300 of a motor which are made in a circular disk shape, the stator 200 being equipped with a stator core 202 and a driving core 201;
an electric power generation coil 204 which is formed of a coreless bonding coil;
a magnet core 301 which is disposed at a circular rotor 300; and
a bypass core 101, 205 which is disposed at both sides of the stator core 202 of the stator 200, thus decreasing magnetic force.

2. A disk motor using a permanent magnet and bypassing the magnetic force of the magnet according to claim 1, wherein said stator 200 and said rotor 300 are made in circular disk shapes, so that the power of the motor can be increased or decreased by stacking or reducing the disk type stator 200 and rotor 300 when it is needed to increase or decrease the motor output, thus increasing or decreasing the power of the motor.

3. A disk motor using a permanent magnet and bypassing the magnetic force of the magnet, comprising:
an electric power generation coil 204 of a coreless bonding coil which is disposed between the stator cores 202 of the stator 200, thus generating electric power.

4. A disk motor using a permanent magnet and bypassing the magnetic force of the magnet, comprising:
a rotor 300 in which a magnet core 301 surrounds a magnet 301a; and
a silicon steel plate 301b or a pure iron which has a small magnetic resistance and surrounds both sides of the same and are adhered, thus forming a magnetic flux passage.

5. A disk motor using a permanent magnet and bypassing the magnetic force of the magnet, comprising:
is a bypass core 101, 205 which is characterized in that when a magnet core 301 is sucked into a stator core 202 and a magnet core enters the position of the bypass core 101, 205, the magnetic force of the magnet core 301 flowing to the stator core 202 is bypassed from the pole N to the pole S by way of the bypass core 101, 205, thus decreasing the magnetic force of the magnet core 301 with respect to the stator core 202.

6. A disk motor using a permanent magnet and bypassing the magnetic force of the magnet, comprising:
a structure in which a rotor 300 is switched with a stator 200, and the stator 200 is switched with the rotor 300, so a rotary shaft 400 functions as a bypass core.

7. A disk motor using a permanent magnet and bypassing the magnetic force of the magnet according to claim 1, wherein said rotor has an air hole 304 of a comb teeth shape, thus cooling motor.
